(19) United States
(12) Patent Application Publication
(10) Pub. No.: US 2008/0085638 A1
(43) Pub. Date: Apr. 10, 2008

(54) Interconnect tower and relay rack assembly

(76) Inventors: Robert C. Baxter, Warwick, RI (US); Glenn T. Kierstead, Coventry, CT (US); Marjana M. Abby, Carolina, RI (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/544,002

(22) Filed: Oct. 6, 2006

(51) Int. Cl. H01R 9/22

(52) U.S. Cl. 439/717

(57) ABSTRACT

A rack assembly has a rack and a first interconnect tower. The rack has a first face to receive a plurality of switches. The first interconnect tower has a second face to receive a first plurality of patch panels. The first interconnect tower is disposed adjacent the rack such that the second face of the first interconnect tower is proximal the first face of the rack allowing shorter patch cords to be used and occupying less floor space. A second interconnect tower having a third face to receive a second plurality of patch panels may be disposed adjacent the rack such that the third face of the second interconnect tower is proximal the first face of the rack.

### FIELD OF THE INVENTION

The present invention relates to a rack assembly in which an interconnect tower is disposed proximal a relay rack to reduce the amount of required floor space, rack space and patch cords. More particularly, the present invention relates to a rack assembly in which a face of an interconnect tower is disposed substantially perpendicularly to a face of a relay rack. Still more particularly, the present invention relates to a rack assembly in which faces of first and second interconnect towers are disposed substantially perpendicularly to first and second ends of a relay rack.

### BACKGROUND OF THE INVENTION

Conventional rack systems for organizing connections between patch panels and switches typically require twice as much rack space for patch panel ports as switch ports. Thus, two entire racks of patch panel ports are required to accommodate an entire rack of switch ports (for example, approximately 1000 switch ports). The patch panels serving the switches occupy valuable rack space, as well as occupying expensive floor space.

A long patch cord is required in the conventional rack systems to connect the switch and patch panel ports. Moreover, a large number of patch cords are typically used within the limited space in which conventional rack systems are maintained. Conventional rack systems typically use numerous channels to facilitate cable management of the numerous long patch cords, thereby occupying more space in the room. Typically, one rack of switches requires two racks of patch panels and four channels to manage patch cords. Thus, a need exists for a rack assembly that reduces the amount of equipment required to house the switches, patch panels and patch cords, thereby freeing floor space.

The long patch cords also create a rat's nest of cabling that is confusing and difficult for an installer to make and break connections. Thus, a need exists for a rack assembly to which switches and patch panels are mounted that reduces the amount of required patch cords and simplifies the arrangement thereof. Cooling is also a major concern in equipment areas. The additional cable bulk inhibits airflow when routed in areas that are also used for cooling airflow.

Thus, there is a continuing need to provide improved rack assemblies to which switches and patch panels are mounted.

### SUMMARY OF THE INVENTION

Accordingly, it is a primary objective of the present invention to provide an improved rack assembly for mounting switches and patch panels to facilitate connection thereof.

A further objective of the present invention is to provide an improved rack assembly including an interconnect tower adapted to receive patch panels and a relay rack adapted to receive switches, thereby using less racks and occupying less floor space.

A still further objective of the present invention is to provide an improved rack assembly in which a face of an interconnect tower is disposed substantially perpendicularly to a face of a relay rack to reduce the amount of required patch cord.

The foregoing objectives are basically attained by a rack assembly having a rack and a first interconnect tower. The rack has a first face adapted to receive a plurality of switches. The first interconnect tower has a second face adapted to receive a first plurality of patch panels. The first interconnect tower is disposed adjacent the rack such that the second face of the first interconnect tower is proximal the first face of the rack, thereby allowing shorter patch cords to be used and occupying less floor space.

The foregoing objectives are also basically attained by a rack assembly having a rack and first and second interconnect towers. The rack has a first face adapted to receive a plurality of switches. The first interconnect tower has a second face adapted to receive a first plurality of patch panels. A second interconnect tower has a third face adapted to receive a second plurality of patch panels. The first and second interconnect towers are disposed adjacent the rack such that the second and third faces of the first and second interconnect towers, respectively, are proximal the first face of the rack, thereby allowing shorter patch cords to be used and occupying less floor space.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

Referring now to the drawings that form a part of the original disclosure:

FIG. 1 is a front perspective view of an interconnect tower according to an exemplary embodiment of the present invention;

FIG. 2 is a rear perspective view of the interconnect tower of FIG. 1;

FIG. 3 is a top plan view of the interconnect tower of FIG. 1;

FIG. 4 is a perspective view of an interconnect tower and rack assembly according to an exemplary embodiment of the present invention;

FIG. 5 is a top plan view of the interconnect tower and rack assembly of FIG. 4;

FIG. 6 is a front perspective view of an interconnect tower and rack assembly according to another exemplary embodiment of the present invention having first and second interconnect towers; and

FIG. 7 is a rear perspective view of the interconnect tower and rack assembly of FIG. 6.

Throughout the drawings, like reference numerals will be understood to refer to like parts, components and structures.

### DETAILED DESCRIPTION OF EXEMPLARY EMBODIMENTS

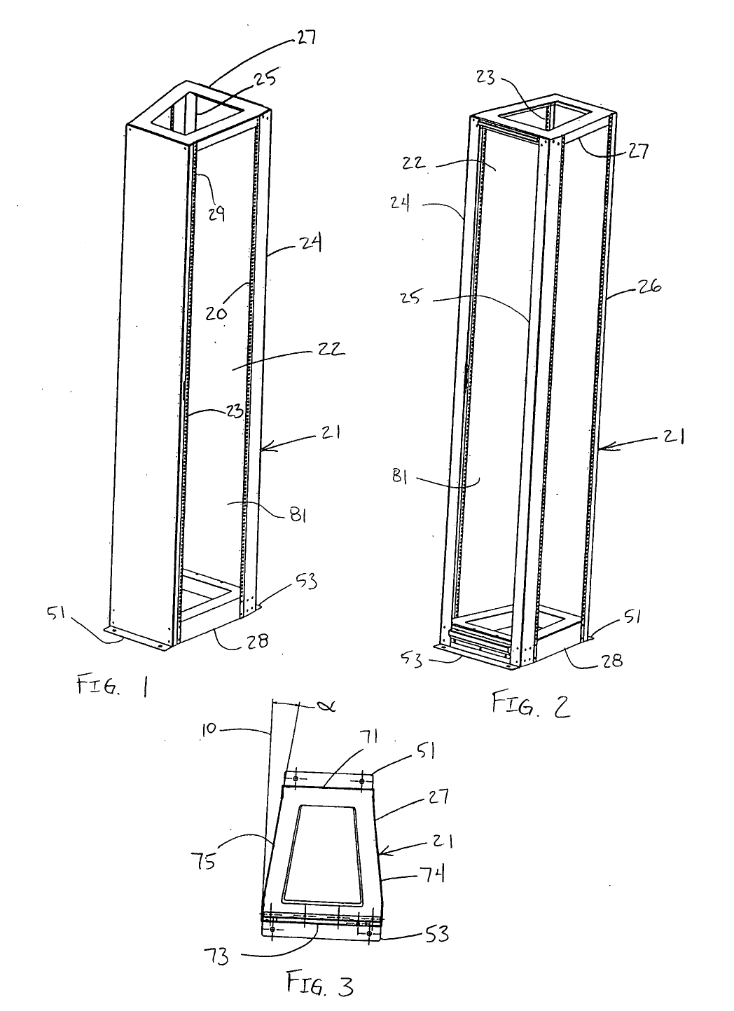

As shown in FIGS. 1-7, exemplary embodiments of the present invention relate to a rack assembly 11 having a first interconnect tower 21 and a rack 31. The rack 31 has a first face 32 adapted to receive a plurality of switches 13. The first interconnect tower 21 has a second face 22 adapted to receive a first plurality of patch panels 12. The first interconnect tower 21 is disposed adjacent the rack 31 such that the second face 22 of the first interconnect tower 21 is proximal the first face 32 of the rack 31, thereby allowing shorter patch cords to be used and occupying less floor space. A second interconnect tower 41 having a third face 42 adapted to receive a second plurality of patch panels 14 may be disposed adjacent the rack 31 such that the third face 42 of the second interconnect tower 41 is proximal the first face 22 of the rack 31 (FIGS. 6 and 7).

The first interconnect tower 21 is shown in FIGS. 1-3. Four vertical members 23, 24, 25 and 26 are disposed between an upper support 27 and a lower support 28. A second face 22 of the first interconnect tower 21 is defined by the first and second vertical members 23 and 24 and the upper and lower supports 27 and 28. An inner edge 29 of the first vertical member 23 defining the second face 22 has a plurality of fastener holes. An inner edge 20 of the second vertical member 24 forming the second face 22 has a plurality of fastener holes. A first plurality of patch panels 12 may be secured in the first face 22 between the fastener holes formed along the edges 29 and 20 of the first and second columns 23 and 24, as shown in FIGS. 4 and 6. Feet 51 and 53 are connected to the first interconnect tower 21 to secure the first interconnect tower to a support, such as the floor 15.

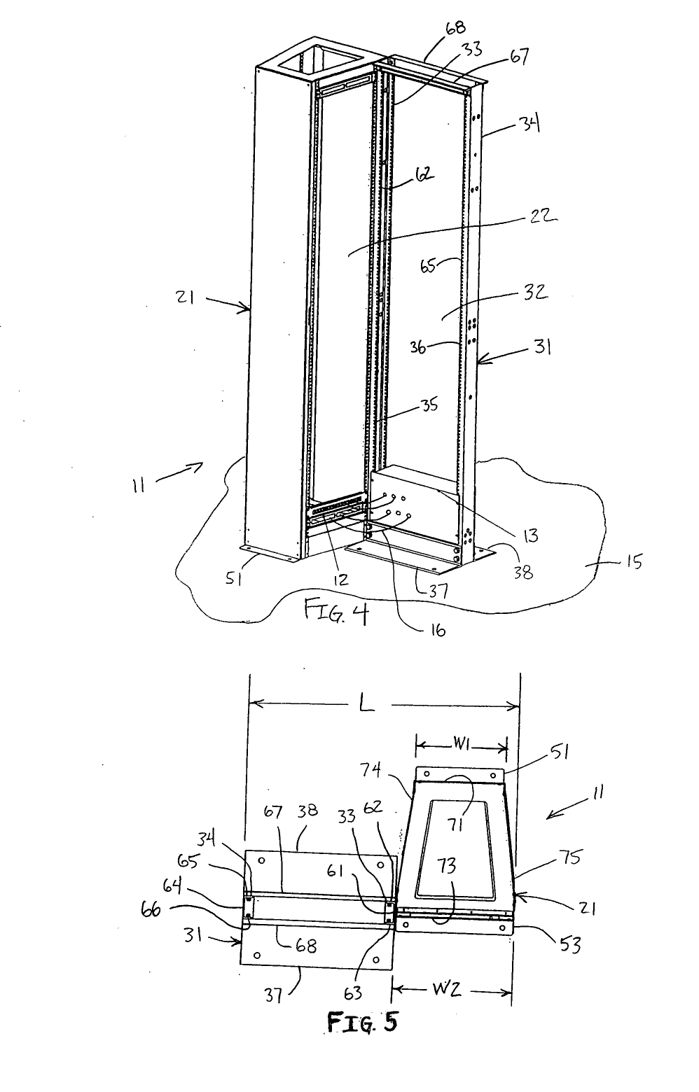

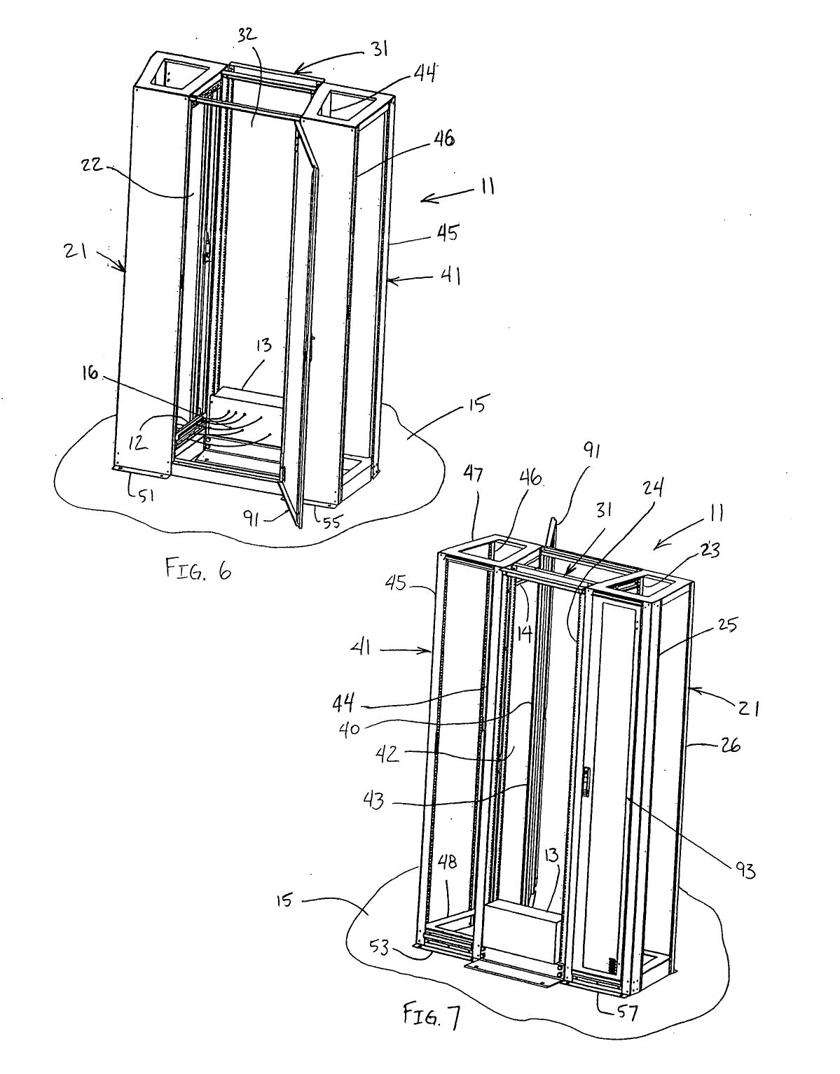

As shown in the top plan views of FIGS. 3 and 5, the front 71 and rear 73 of the first interconnect tower 31 are substantially parallel. First and second sides 74 and 75 connect the front 71 and rear 73 to form an isosceles trapezoid. An angle α is formed between the second side 75 and a line extending perpendicularly from the rear 73 of the first interconnect tower 21, as shown in FIG. 3. Preferably, the angle α is between approximately zero and ten degrees, and more preferably the angle α is approximately eight degrees. Thus, the second side 75 forms an angle with the rear 73 between approximately 80 and 90 degrees, and more preferably about 82 degrees. An angle formed between the first side 74 and the rear 73 is substantially similar to that of the second side 75. A fourth face 81 of the first interconnect tower 21 is defined by the second and third vertical members 24 and 25. Therefore, the fourth face 81 is at an angle with respect to the second face 22 between approximately 80 and 90 degrees, and more preferably about 82 degrees. Preferably, the width W1 of the front 71 of the first interconnect tower 21 is less than the width W2 of the rear 73 of the first interconnect tower, as shown in FIG. 5.

The rack 31, as shown in FIGS. 4-7, has first and second vertical members 33 and 34. Preferably, the first and second vertical members 33 and 34 are C-shaped channels, although any suitable vertical member may be used. The first vertical member 33 has a base 61 and two legs 62 and 63 extending substantially perpendicularly therefrom, as shown in FIG. 5. A first plurality of fastener holes 35 extends along the leg 62. The second vertical member 34 has a base 64 and two legs 65 and 66 extending substantially perpendicularly therefrom. A second plurality of fastener holes 36 extends along the leg 65. A plurality of switches 13 are connected between the first and second plurality of fastener holes 35 and 36 of the rack 31. Feet 37 and 38 are connected between the first and second vertical members 33 and 34 to secure the rack 31 to a support, such as the floor 15. Upper supports 67 and 68 are connected between the first and second vertical members 33 and 34 to provide stability to the rack 31. The first face 32 of the rack 31 is defined by the legs 62 and 65 of the first and second vertical members 33 and 34, the upper support 67 and the foot 37.

The second interconnect tower 41 is substantially similar to the first interconnect tower 21, as shown in FIGS. 6 and 7. Four vertical members 43, 44, 45 and 46 are disposed between an upper support 47 and a lower support 48. A third face 42 of the second interconnect tower 41 is defined by the first and second vertical members 43 and 44 and the upper and lower supports 47 and 48. An edge (not shown) of the first vertical member 43 defining the third face 42 has a plurality of fastener holes. An edge 40 of the second vertical member 24 forming the third face 42 has a plurality of fastener holes. A second plurality of patch panels 14 may be secured in the third face 42 between the fastener holes formed along the edges of the first and second vertical members 23 and 24, as shown in FIG. 6. Feet 55 and 57 are connected to the second interconnect tower 41 to secure the second interconnect tower to a support, such as the floor 15.

A first door 91 may be connected between the first and second interconnect towers 21 and 41 to control access thereto, as shown in FIG. 6. A second door 93 may be connected to the second and third vertical members 24 and 25 of the first interconnect tower 21, as shown in FIG. 7, to control access thereto. Similarly, a door (not shown) may be connected to the second and third vertical members 44 and 45 of the second interconnect tower 41.

Preferably, the first and second interconnect towers 21 and 41 and the rack 31 are made of a metal, such as steel.

### Assembly and Disassembly

As shown in FIGS. 4 and 5, a first interconnect tower 21 is disposed adjacent the rack 31 such that the second face 22 of the first interconnect tower 21 is proximal the first face 32 of the rack 31. The feet 51 and 53 of the first interconnect tower 21 are secured to the floor 15. The feet 37 and 38 of the rack 31 are secured to the floor 15. Preferably, the first interconnect tower 21 and the rack 31 are not directly mechanically connected.

A first plurality of patch panels 12 are connected in the second face 32 between the first and second vertical columns 23 and 24 of the first interconnect tower 21. A plurality of switches 13 are connected in the first face 32 between the legs 62 and 65 of the relay 31. Patch cords 16 are connected between electrical connectors received by the patch panels and the appropriate ports of the switches 13. Relatively short patch cords 16 may be used between the patch panels 12 and the switches 13 because the second face 22 of the first interconnect tower 21 is proximal the first face 32 of the rack 31, thereby requiring substantially less patch cords than in conventional rack systems. Preferably, the angle formed between the second and first faces 22 and 32 is between approximately eighty and ninety degrees, and more preferably is approximately 82 degrees.

Preferably, the length L of the first interconnect tower 21 and the rack 31, as shown in FIG. 5, is approximately 36 inches compared to the configuration of conventional rack systems requiring a length of approximately 84 inches. Thus, the configuration of the rack assembly 11 of the exemplary embodiments of the present invention requires less floor space, thereby allowing the unoccupied space to be used for other purposes.

A second interconnect tower 41 is disposed adjacent the rack 31, as shown in FIGS. 6 and 7, such that the fourth face 42 of the second interconnect tower 41 is proximal the first face 32 of the rack 31. The feet 55 and 57 of the second interconnect tower are secured to the floor 15. Preferably the second interconnect tower 41 and the rack 31 are not directly mechanically connected. A second plurality of patch panels 14 are connected in the fourth face 42 between the first and second vertical columns 43 and 44 of the second interconnect tower 41. Patch cords 16 are connected between electrical connectors received by the patch panels 14 and the appropriate ports of the switches 13. Relatively short patch cords 16 may be used between the patch panels 14 and the switches 13 because the fourth face 42 of the second interconnect tower 41 is proximal the first face 32 of the rack 31. Preferably, the angle formed between the fourth and first faces 42 and 32 is between approximately eighty and ninety degrees, and more preferably is approximately 82 degrees. Preferably, the second face 22 of the first interconnect tower 21 in which the first plurality of patch panels 12 are disposed and the fourth face 42 of the second interconnect tower 41 in which the second plurality of patch panels 14 are disposed are substantially parallel.

A first door 91 may be connected between vertical columns 23 and 43 of the first and second interconnect towers 21 and 41, as shown in FIGS. 6 and 7, to provide access to the first and second plurality of patch panels 12 and 14, the plurality of switches 13 and the patch cords 16. A second door 93 may be connected between vertical members 24 and 25 of the first interconnect tower 21 to provide access to the first plurality of patch panels 12, the plurality of switches 13 and the patch cords 16. Similarly, a door may be connected between vertical members 44 and 45 of the second interconnect tower 41 to provide access to the second plurality of patch panels 14, the plurality of switches 13 and the patch cords 16.

While advantageous embodiments have been chosen to illustrate the invention, it will be understood by those skilled in the art that various changes and modifications may be made therein without departing from the scope of the invention as defined in the appended claims.

What is claimed is:

1. A rack assembly, comprising:
a rack having a first face formed to receive a plurality of switches; and
a first interconnect tower having a second face formed to receive a first plurality of patch panels, said first interconnect tower being disposed adjacent said rack such that said second face of said first interconnect tower is proximal said first face of said rack.

2. A rack assembly according to claim 1, wherein
said second face of said interconnect tower is approximately perpendicular to said first face of said rack.

3. A rack assembly according to claim 1, wherein
said rack and said first interconnect tower are secured to a support, and said first interconnect tower is not directly mechanically connected to said rack.

4. A rack assembly according to claim 1, wherein
a second interconnect tower having a third face formed to receive a second plurality of patch panels, said second interconnect tower being disposed adjacent said rack such that said third face of said second interconnect tower is proximal said first face of said rack.

5. A rack assembly according to claim 4, wherein
said third face of said second interconnect tower is substantially parallel to said second face of said first interconnect tower.

6. A rack assembly according to claim 4, wherein
said rack and said first and second interconnect towers are secured to a support, and said first and second interconnect towers are not directly mechanically connected to said rack.

7. A rack assembly according to claim 4, wherein
a first door is connected between said first and second interconnect towers to provide access thereto.

8. A rack assembly according to claim 7, wherein
a second door is connected to said first interconnect tower to provide access thereto.

9. A rack assembly according to claim 1, wherein
said second face of said first interconnect tower is disposed at an angle of approximately eight degrees with respect to said first face of said rack.

10. A rack assembly, comprising:
a rack having a first face receiving a plurality of switches, said rack being secured to a support; and
a first interconnect tower having a second face receiving a first plurality of patch panels, an angle between said second face and a third face of said interconnect tower being approximately 82 degrees, said first interconnect tower being secured to the support, and said first interconnect tower being disposed adjacent said rack such that said second face of said first interconnect tower is proximal said first face of said rack.

11. A rack assembly according to claim 10, wherein
said second face of said interconnect tower is approximately perpendicular to said first face of said rack.

12. A rack assembly according to claim 10, wherein
said first interconnect tower is not directly mechanically connected to said rack.

13. A rack assembly according to claim 10, wherein
a second interconnect tower having a fourth face receiving a second plurality of patch panels, said second interconnect tower being disposed adjacent said rack such that said third face of said second interconnect tower is proximal said first face of said rack, and said second interconnect tower being secured to the support.

14. A rack assembly according to claim 13, wherein
said fourth face of said second interconnect tower is substantially parallel to said second face of said first interconnect tower.

15. A rack assembly according to claim 13, wherein
said first and second interconnect towers are not directly mechanically connected to said rack.

16. A rack assembly according to claim 13, wherein
a first door is connected between said first and second interconnect towers to provide access thereto.

17. A rack assembly according to claim 16, wherein
a second door is connected to said third face of said first interconnect tower to provide access thereto.

18. A rack assembly according to claim 10, wherein
said second face of said first interconnect tower is disposed at an angle of approximately eight degrees with respect to said first face of said rack.

19. A rack assembly, comprising:
a rack having a first face receiving a plurality of switches, said rack being secured to a support;
a first interconnect tower having a second face receiving a first plurality of patch panels; and
a second interconnect tower having a third face receiving a second plurality of patch panels, said first and second interconnect towers being disposed adjacent said rack such that said second and third faces of said first and second interconnect towers, respectively, are proximal said first face of said rack and have an angle between approximately eighty and approximately ninety degrees between each of said second and third faces of said first and second interconnect towers and said first face of said rack.
